(19) United States
(12) Patent Application Publication
(10) Pub. No.: US 2023/0327837 A1
(43) Pub. Date: Oct. 12, 2023

(54) BEACON TIMESLOT ALLOCATION METHOD, APPARATUS, AND DEVICE

(71) Applicants: Beijing SmartChip Microelectronics Technology Co., Ltd., Beijing (CN); State Grid Corporation of China, Beijing (CN)

(72) Inventors: Dongyan Zhao, Beijing (CN); Dan Luo, Beijing (CN); Zheng Li, Beijing (CN); Deyong Xiao, Beijing (CN); Xianhui Wang, Beijing (CN); Kunpeng Xu, Beijing (CN); Xiaohui Zhang, Beijing (CN); Fuyu Pei, Beijing (CN); Jin Shao, Beijing (CN); Qian Zhang, Beijing (CN)

(21) Appl. No.: 18/195,392

(22) Filed: May 10, 2023

Related U.S. Application Data
(63) Continuation-in-part of application No. PCT/CN2022/133892, filed on Nov. 24, 2022.

(30) Foreign Application Priority Data
Apr. 8, 2022 (CN) 202210365789.5

(51) Int. Cl. H04L 5/00; H04B 3/54

(52) U.S. Cl. CPC H04L 5/0053; H04B 3/54

(57) ABSTRACT

Disclosed are a beacon timeslot allocation method, apparatus, and device. The method includes: determining, based on a type of a beacon frame sent by a node in a system on a highspeed radio frequency (HRF) link, a node sending a standard beacon frame as a first-type node, and a node sending a simplified beacon frame as a second-type node; and in a process of sending a beacon frame on the HRF link by one first-type node, scheduling at least one first-type node and/or second-type node that have/has not been scheduled to perform sending on a highspeed power line carrier (HPLC) link yet to send a beacon frame on the HPLC link, where the scheduled first-type node and/or second-type node do/does not include the one first-type node or a node on a path between the one first-type node and a central coordinator (CCO) in the system.

### CROSS REFERENCE TO RELATED APPLICATIONS

The present application is a Continuation-In-Part Application of PCT Application No. PCT/CN2022/133892 filed on Nov. 24, 2022, which claims the benefit of Chinese Patent Application No. 202210365789.5 filed on Apr. 8, 2022. All the above are hereby incorporated by reference in their entirety.

### TECHNICAL FIELD

The present disclosure relates to the technical field of dual-mode communication, and specifically, to a beacon timeslot allocation method, a beacon timeslot allocation apparatus, a beacon timeslot allocation device, and a storage medium.

### BACKGROUND

An HPLC+HRF dual-mode network is a network that adopts two different transmission modes for complementation. A node chooses one of the two transmission modes based on a specific situation to improve an anti-interference capability of communication and increase robustness of the network. Each node needs to send a beacon frame on HPLC and HRF channels separately. Total time of beacon timeslots in a beacon cycle is multiplied, which will inevitably reduce channel resources for service data transmission.

In theory, the HPLC and HRF channels allow sending and reception at the same time without mutual interference. If a module sends the beacon frame simultaneously on the HPLC and HRF channels in a beacon timeslot, an overall length of the beacon timeslot can be greatly shortened, and more channel resources can be released for service data transmission. However, this will cause another problem. That is, when two sending ends work at the same time, a transient power consumption of the module also increases. Solutions in the prior art are briefly described below:

In an existing technical solution 1, for a node, a beacon timeslot is separately allocated to the HPLC and HRF channels. This can prevent the transient power consumption from exceeding a standard, but a proportion of the beacon timeslot in the whole beacon cycle of the network is too large, reducing a channel utilization rate.

In an existing technical solution 2, for a node, a same beacon timeslot is allocated to the HPLC and HRF channels. This can reduce the proportion of the beacon timeslot in the beacon cycle compared with the technical solution 1, but the transient power consumption may exceed the standard.

Interpretation of Terms in the Claims:

Standard beacon frame: Regulated by Technical Specification for Interconnection and Interoperability of Dual-mode Communication, the standard beacon frame inherits a format of an HPLC beacon frame, and is 72/136/264/520 bytes long.

HPLC: It is short for highspeed power line carrier.

HRF: It is short for highspeed radio frequency.

### SUMMARY

Embodiments of the present disclosure are intended to provide a beacon timeslot allocation method, apparatus, and device, to resolve at least some of the above problems.

To achieve the above objective, a first aspect of the present disclosure provides a beacon timeslot allocation method, applied to a system with dual-mode networking of an HPLC link and an HRF link, where the method includes: determining, based on a type of a beacon frame sent by a node in the system on the HRF link, a node sending a standard beacon frame as a first-type node, and a node sending a simplified beacon frame as a second-type node; and in a process of sending a beacon frame on the HRF link by one first-type node, scheduling at least one first-type node and/or second-type node that have/has not been scheduled to perform sending on the HPLC link yet to send a beacon frame on the HPLC link, where the scheduled first-type node and/or second-type node do/does not include the one first-type node or a node on a path between the one first-type node and a central coordinator (CCO) in the system.

Preferably, when there are a plurality of first-type nodes in the system, the method further includes: determining a sending order of the plurality of first-type nodes on the HRF link based on a topological relationship between the plurality of first-type nodes and the CCO in the system.

Preferably, in the process of sending the beacon frame on the HRF link by the one first-type node, when there is more than one first-type node and/or second-type node scheduled to send a beacon frame on the HPLC link, the method further includes: determining a sending order of scheduled nodes on the HPLC link based on a topological relationship between the scheduled nodes and the CCO in the system.

Preferably, the determining a sending order of the plurality of first-type nodes on the HRF link based on a topological relationship between the plurality of first-type nodes and the CCO in the system, or the determining a sending order of scheduled nodes on the HPLC link based on a topological relationship between the scheduled nodes and the CCO in the system includes: determining the sending order according to a rule that a non-leaf node is prior to a leaf node; when there are only non-leaf nodes, determining the sending order through level order traversal; and when there are only leaf nodes, determining the sending order from left to right based on a topological graph.

Preferably, in the process of sending the beacon frame on the HRF link by the one first-type node, the at least one first-type node and/or second-type node, which have/has not been scheduled to perform sending on the HPLC link yet, scheduled to send the beacon frame on the HPLC link do/does not include: a sub-node that is of the one first-type node and connected by using the HRF link; an ancestor node of the first-type node before the one first-type node; and a descendant node of the first-type node after the one first-type node.

Preferably, in the process of sending the beacon frame on the HRF link by the one first-type node, quantities and/or a quantity of first-type nodes and/or second-type nodes scheduled to send the beacon frame on the HPLC link are/is jointly determined based on following parameters: time for the first-type node to send the beacon frame on the HRF link, and time for the second-type node to send the beacon frame on the HPLC link.

Preferably, the method further includes: calculating a ratio of the time for the first-type node to send the beacon frame on the HRF link to the time for the second-type node to send the beacon frame on the HPLC link; and rounding up the ratio, and then subtracting 1 from an obtained ratio as the quantities/the quantity of first-type nodes and/or second-type nodes scheduled to send the beacon frame on the HPLC link.

Preferably, the time for the first-type node to send the beacon frame on the HRF link and the time for the second-type node to send the beacon frame on the HPLC link are both related to a length of the beacon frame, and are also related to rates of respective links.

Preferably, the method further includes: interchanging positions of same-level first-type nodes in the sending order reciprocally.

Preferably, the positions of the same-level first-type nodes are interchanged reciprocally when a following configuration is met: among the same-level first-type nodes, an entropy value of an anterior first-type node is less than an entropy value of a posterior first-type node, where the entropy value of the first-type node is used to represent a quantity of second-type nodes under the first-type node.

Preferably, the entropy value of the first-type node is determined by performing following steps: performing level order traversal in subtrees of the first-type node, and counting the quantity of second-type nodes during the traversal; and if the first-type node is encountered during the traversal, stopping the traversal of a branch, and taking, as the entropy value of the first-type node, the quantity of second-type nodes that is obtained after completing the traversal.

Preferably, the method further includes: allocating sequentially, to each node based on an order of sending the beacon frame by the node in the system on the HPLC link, a time division multiple address (TDMA) timeslot for sending an HPLC beacon.

Preferably, the method further includes: allocating, based on an order that the first-type node is prior to the second-type node, a TDMA timeslot for sending an HRF beacon.

Preferably, the method further includes: allocating, based on an order that the first-type node is prior to the second-type node, a TDMA timeslot and a CSMA timeslot for sending an HRF beacon.

A second aspect of the present disclosure provides a beacon timeslot allocation apparatus, applied to a system with dual-mode networking of an HPLC link and an HRF link, where the apparatus includes: a node classification module configured to determine, based on a type of a beacon frame sent by a node in the system on the HRF link, a node sending a standard beacon frame as a first-type node, and a node sending a simplified beacon frame as a second-type node; and a timeslot scheduling module configured to: in a process of sending a beacon frame on the HRF link by one first-type node, schedule at least one first-type node and/or second-type node that have/has not been scheduled to perform sending on the HPLC link yet to send a beacon frame on the HPLC link, where the scheduled first-type node and/or second-type node do/does not include the one first-type node or a node on a path between the one first-type node and a CCO in the system.

Preferably, when there are a plurality of first-type nodes in the system, a sending order of the plurality of first-type nodes on the HRF link is determined based on a topological relationship between the plurality of first-type nodes and the CCO in the system.

Preferably, in the process of sending the beacon frame on the HRF link by the one first-type node, when there is more than one first-type node and/or second-type node scheduled to send a beacon frame on the HPLC link, a sending order of scheduled nodes on the HPLC link is determined based on a topological relationship between the scheduled nodes and the CCO in the system.

Preferably, the determining a sending order of the plurality of first-type nodes on the HRF link based on a topological relationship between the plurality of first-type nodes and the CCO in the system, or the determining a sending order of scheduled nodes on the HPLC link based on a topological relationship between the scheduled nodes and the CCO in the system includes: determining the sending order according to a rule that a non-leaf node is prior to a leaf node; when there are only non-leaf nodes, determining the sending order through level order traversal; and when there are only leaf nodes, determining the sending order from left to right based on a topological graph.

Preferably, in the process of sending the beacon frame on the HRF link by the one first-type node, the at least one first-type node and/or second-type node, which have/has not been scheduled to perform sending on the HPLC link yet, scheduled to send the beacon frame on the HPLC link do/does not include: a sub-node that is of the one first-type node and connected by using the HRF link; an ancestor node of the first-type node before the one first-type node; and a descendant node of the first-type node after the one first-type node.

Preferably, in the process of sending the beacon frame on the HRF link by the one first-type node, a quantity of nodes scheduled to send the beacon frame on the HPLC link is jointly determined based on following parameters: time for the first-type node to send the beacon frame on the HRF link, and time for the second-type node to send the beacon frame on the HPLC link.

Preferably, a ratio of the time for the first-type node to send the beacon frame on the HRF link to the time for the second-type node to send the beacon frame on the HPLC link is calculated; and the ratio is rounded up, and then 1 is subtracted from an obtained ratio as a quantity of second-type nodes scheduled to send the beacon frame on the HPLC link.

Preferably, the time for the first-type node to send the beacon frame on the HRF link and the time for the second-type node to send the beacon frame on the HPLC link are both related to a length of the beacon frame, and are also related to rates of respective links.

Preferably, the apparatus is further configured to interchange positions of same-level first-type nodes in the sending order reciprocally.

Preferably, the positions of the same-level first-type nodes are interchanged reciprocally when a following configuration is met: among the same-level first-type nodes, an entropy value of an anterior first-type node is less than an entropy value of a posterior first-type node, where an entropy value of a node is used to represent a quantity of second-type nodes under the first-type node.

Preferably, the entropy value of the first-type node is determined by performing following steps: performing level order traversal in subtrees of the first-type node, and counting the quantity of second-type nodes during the traversal; and if the first-type node is encountered during the traversal, stopping the traversal of a branch, and taking, as the entropy value of the first-type node, the quantity of second-type nodes that is obtained after completing the traversal.

Preferably, the apparatus is further configured to allocate sequentially, to each node based on an order of sending the beacon frame by the node in the system on the HPLC link, a TDMA timeslot for sending an HPLC beacon.

Preferably, the apparatus is further configured to allocate, based on an order that the first-type node is prior to the second-type node, a TDMA timeslot for sending an HRF beacon.

Preferably, the apparatus is further configured to allocate, based on an order that the first-type node is prior to the second-type node, a TDMA timeslot and a CSMA timeslot for sending an HRF beacon.

A third aspect of the present disclosure provides a beacon timeslot allocation device, including a memory, a processor, and a computer program stored in the memory and able to run on the processor, where the processor executes the computer program to implement steps of the aforementioned beacon timeslot allocation method.

A fourth aspect of the present disclosure provides a dual-mode communication networking device, including an HPLC communication module and an HRF communication module, where both the HPLC communication module and the HRF communication module are communicatively coupled with a controller, and the controller is configured to control the HPLC communication module and the HRF communication module to send a beacon on a beacon sending timeslot determined according to the aforementioned beacon timeslot allocation method.

A fifth aspect of the present disclosure provides a chip, including a memory, a processor, and a computer program stored in the memory and able to run on the processor, where the processor executes the computer program to implement steps of the aforementioned beacon timeslot allocation method.

A sixth aspect of the present disclosure provides a computer-readable storage medium, where the computer-readable storage medium stores an instruction, and when the instruction runs on a computer, the computer performs steps of the aforementioned beacon timeslot allocation method.

A seventh aspect of the present disclosure provides a computer program product, including a computer program. The computer program is executed by a processor to implement the aforementioned beacon timeslot allocation method.

The above technical solutions have following beneficial effects.

An HPLC beacon timeslot used by a node to send a simplified HRF beacon frame is overlapped with an HRF beacon timeslot used by a node to send a standard HRF beacon frame, such that a plurality of HPLC beacon frames and HRF standard beacon frames are sent simultaneously. This reduces bandwidth resources occupied for the beacon frame, and prevents the node from sending data on HRF and HPLC channels at the same time, reducing a transient power consumption of a device. The implementations of the present disclosure also have advantages of low algorithm complexity and easy implementation.

Other features and advantages of embodiments of the present disclosure are described in detail in the subsequent specific implementation part.

### BRIEF DESCRIPTION OF THE DRAWINGS

The accompanying drawings are provided for further understanding of the embodiments of the present disclosure, and constitute a part of the specification. The accompanying drawings and the following specific implementations are intended to explain the embodiments of the present disclosure, rather than to limit the embodiments of the present disclosure. In the accompanying drawings:

FIG. 1 schematically shows implementation of a beacon timeslot allocation method according to an implementation of the present disclosure;

FIG. 2 schematically shows a topological relationship between a node and a link in an example system 1 according to an implementation of the present disclosure;

FIG. 3 schematically shows a change process of an initial timeslot allocation sequence based on an example system 1 according to an implementation of the present disclosure;

FIG. 4 schematically shows timeslots in a beacon cycle in the prior art;

FIG. 5 schematically shows a beacon timeslot allocation obtained based on an example system 1 according to an implementation of the present disclosure;

FIG. 6 schematically shows a topological relationship between a node and a link in an example system 2 according to an implementation of the present disclosure;

FIG. 7 schematically shows a change process of an initial timeslot allocation sequence based on an example system 2 according to an implementation of the present disclosure;

FIG. 8 schematically shows a beacon timeslot allocation obtained based on a scenario 1 of an example system 2 according to an implementation of the present disclosure;

FIG. 9 schematically shows a beacon timeslot allocation obtained based on a scenario 2 of an example system 2 according to an implementation of the present disclosure;

FIG. 10 schematically shows a topological relationship between a node and a link in an example system 3 according to an implementation of the present disclosure;

FIG. 11 schematically shows a change process of an initial timeslot allocation sequence based on an example system 3 according to an implementation of the present disclosure;

FIG. 12 schematically shows a beacon timeslot allocation obtained based on an example system 3 according to an implementation of the present disclosure; and

FIG. 13 is a schematic structural diagram of a beacon timeslot allocation apparatus according to an implementation of the present disclosure.

### DETAILED DESCRIPTION

Specific implementations of the embodiments of the present disclosure are described in detail below with reference to the accompanying drawings. It should be understood that the specific implementations described herein are merely intended to illustrate and interpret the embodiments of the present disclosure, rather than to limit the embodiments of the present disclosure.

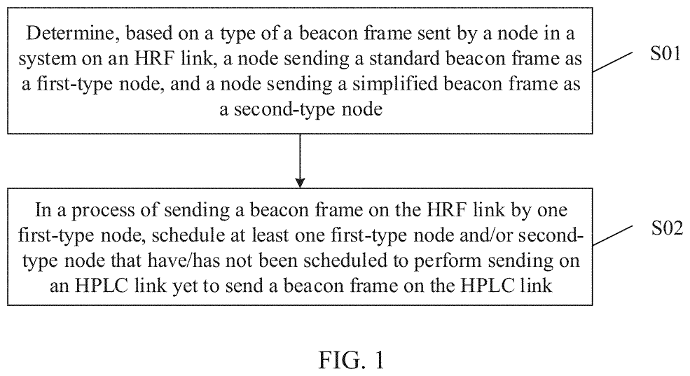

FIG. 1 schematically shows implementation of a beacon timeslot allocation method according to an implementation of the present disclosure. As shown in FIG. 1, the beacon timeslot allocation method provided in this implementation includes following steps.

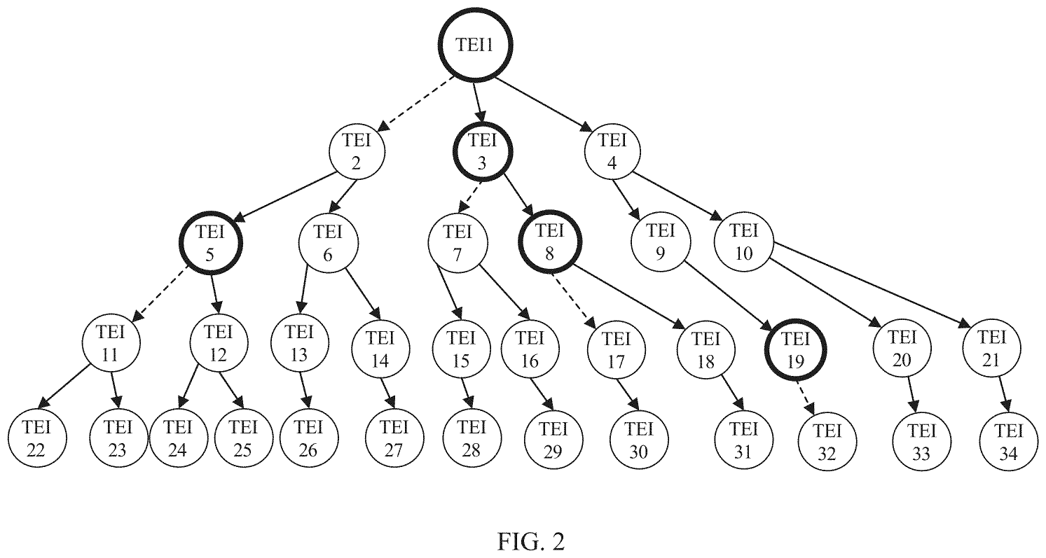

S01: Determine, based on a type of a beacon frame sent by a node in a system on an HRF link, a node sending a standard beacon frame as a first-type node, and a node sending a simplified beacon frame as a second-type node. FIG. 2 schematically shows a topological relationship between a node and a link in an example system 1 according to an implementation of the present disclosure. This implementation is described with reference to FIG. 2. The system in FIG. 2 includes the node (terminal equipment identifier (TEI)) and the link. Because dual-mode networking is adopted, there are the HRF link and an HPLC link. In the figure, a dotted line represents the HRF link, and a solid line represents the HPLC link. This setting is followed in subsequent accompanying drawings. Based on existing technical specifications, beacon frames in different formats are transmitted on an HRF channel, in other words, data sizes of beacon frames that need to be transmitted are different. Combined with other factors, time for a node to completely send the beacon frame can be obtained. The time also represents a length of a timeslot required by the node to send the beacon frame. In this step, nodes are classified based on different sending time of the beacon frame, providing a basis for subsequent steps. It can also be seen from FIG. 2 that a shadowed or bold node in the figure is the first-type node after the classification, in other words, a sending-end node of the HRF link in FIG. 2. A last-level node and a proxy node of a sub-node that is not connected to a network by using the HRF link are second-type nodes.

S02: In a process of sending a beacon frame on the HRF link by one first-type node, schedule at least one first-type node and/or second-type node that have/has not been scheduled to perform sending on the HPLC link yet to send a beacon frame on the HPLC link, where the scheduled first-type node and/or second-type node do/does not include the one first-type node or a node on a path between the one first-type node and a CCO in the system.

Based on the existing technical specifications and a beacon sending mechanism of the CCO, as the proxy node, a non-leaf node in the system needs to forward the beacon frame. Therefore, it can be concluded that under a topological relationship between the node and the link in the system, each node receives the standard beacon frame from a root node (CCO) in a certain chronological order. It can be determined that since the standard beacon frame of the node in the system is forwarded by a parent node of the node, the parent node on a transmission path inevitably receives the standard beacon frame earlier than the node. Therefore, when a sending order of the node is adjusted, a timing sequence of the standard beacon frame arriving at the node should be considered to avoid a situation that the parent node is behind the node. In order to avoid simultaneous sending in the prior art, it is necessary to exclude the one first-type node itself. In a system using HPLC and HRF dual-mode networking, a plurality of beacon timeslots need to be occupied to send the standard beacon frame on the HRF channel, which means that one HRF standard beacon frame is sent simultaneously with HPLC beacon frames of a plurality of nodes. How to schedule a beacon timeslot of each node in the network is a core technical point of this solution. If a node has sent a beacon frame on the HPLC link in a corresponding beacon cycle, the node will not be scheduled to send the beacon frame again. Therefore, it is necessary to select, from an available node set, at least one node that has not been scheduled to perform sending on the HPLC link yet. When a plurality of nodes are selected, in a time division multiplexing system, these nodes are scheduled to perform sending in sequence, which is reflected in overlapping between a plurality of sending timeslots of the HPLC channel and one HRF beacon timeslot.

In the above implementation, a proportion of the beacon timeslot in the beacon cycle is reduced by allocating the beacon timeslot reasonably, thereby greatly improve a utilization rate of a channel transmission service. In addition, an increase in a transient power consumption because the node sends data on the HPLC and HRF channels at the same time is avoided. The above implementation of the present disclosure has advantages of two existing technical solutions.

In the aforementioned implementation, provided that the HPLC and HRF channels are used for simultaneous sending, the simultaneous sending can be avoided, and sending efficiency can be improved. However, in this implementation, a node scheduling manner is not limited. In some optional implementations, it is necessary to determine a sending order of a plurality of first-type nodes, a sending node of a plurality of second-type nodes, and a sending order of a plurality of first-type nodes and second-type nodes. The sending order may be an ordered sequence obtained by selecting one of a plurality of traversal modes of a tree. Optional traversal modes herein include but are not limited to pre-order traversal, mid-order traversal, post-order traversal, level order traversal, reverse level order traversal, and a combination thereof.

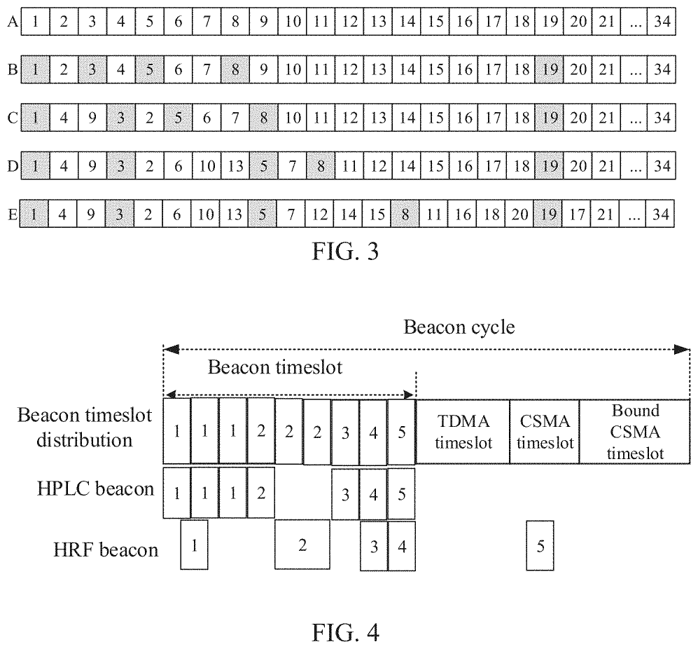

As a further improvement of the aforementioned implementation, the sending order of the node can be determined in a following manner: determining the sending order based on a topological relationship between the node and the CCO in the system, which includes following operations: determining the sending order according to a rule that the non-leaf node is prior to a leaf node; when there are only non-leaf nodes, determining the sending order through the level order traversal; and when there are only leaf nodes, determining the sending order from left to right based on a topological graph. In this implementation, an initial timeslot allocation sequence obtained based on the topological relationship in FIG. 2 is shown in a row A in FIG. 3. The sending order in the row A includes both the sending order of the plurality of first-type nodes and the sending order of the plurality of second-type nodes. FIG. 3 schematically shows an allocation process of an initial timeslot allocation sequence based on the example system 1 according to an implementation of the present disclosure. Due to a limitation of a page size, some nodes in FIG. 3 are omitted. The omitted nodes are TEI22 to TEI33 that are arranged in an order of natural numbers.

Based on a specification, after receiving a beacon frame of a parent node, the proxy node in the system needs to forward the beacon frame to its sub-node. The beacon frame may be a discovery beacon. In implementations for some practical scenarios, when the CCO starts to send a beacon frame, a node order can be obtained based on a chronological order of receiving the beacon frame by each node. It can be seen that this order is also reflected in a topological structure of the system. Therefore, based on a topological position of the first-type node in the system, after the one first-type node and its ancestor node are excluded, a node set composed of nodes that can perform sending with the first-type node at the same time can be obtained for alternative simultaneous sending.

As a further improvement of the aforementioned implementation, an exclusion rule is added to further narrow an optional node set to achieve a better implementation effect. The added exclusion rule is used to exclude following nodes: a sub-node that is of the one first-type node and connected by using the HRF link; an ancestor node of the first-type node before the one first-type node; and a descendant node of the first-type node after the one first-type node. After the above exclusion rule is adopted, a quantity of nodes that can perform sending with a first-type node at the same time is further reduced, but an allocation speed on the HRF channel is significantly improved.

The above implementations provide a manner of selecting a node that performs simultaneous sending and improve utilization of a bandwidth resource, but the utilization effect is not necessarily the best. A shortest beacon timeslot can be obtained at a system level only when the HRF channel and the HPLC channel have no conflict and each maintain a high utilization rate, so as to obtain an optimal timeslot allocation scheme. In following implementations, a manner of determining a quantity of scheduled nodes is provided.

In some optional implementation, in the process of sending the beacon frame on the HRF link by the one first-type node, a quantity of nodes scheduled to send the beacon frame on the HPLC link is jointly determined based on following parameters: time for the first-type node to send the beacon frame on the HRF link, and time for the second-type node to send the beacon frame on the HPLC link. Based on a specification and the above description, there are a variety of beacon frames, such as the standard beacon frame and the simplified beacon frame. The HRF link and the HPLC link also have different rates. Therefore, time used by a plurality of sent beacon frames can be obtained through arrangement and combination. It is obvious that it takes longest time to send a long beacon frame on a low-rate link. Because the HRF link has a lower rate than the HPLC link, time spent on the HRF link is longer. For example, assuming that a timeslot length of one HRF standard beacon frame is equal to that of 5 HPLC beacon frames, an HRF standard beacon frame of the first-type node needs to be synchronously sent with HPLC beacons of 5 second-type nodes. Herein, the quantity 5 is an ideal quantity. It should be noted that the quantity 5 herein is only for convenience of illustration. Therefore, a quantity of HPLC beacon frames whose total timeslot length is equal to the timeslot length of the HRF standard beacon frame is assumed. Actually, the implementation provided in the present disclosure is applicable to any scenario in which the quantity of HPLC beacon frames whose total timeslot length is equal to the timeslot length of the HRF standard beacon frame is greater than 1. For example, if an HPLC transmission rate/an HRF transmission rate=2.2, the ideal quantity is 2.

If there are nodes of the ideal quantity that send the beacon frame on the HPLC link when each first-type node sends the beacon frame on the HRF link, the proportion of the beacon timeslot in the beacon cycle is lowest, and an ideal state is reached at this time. When a quantity of nodes sending the beacon frame on the HPLC link is less than the ideal quantity, a radio beacon occupies the beacon timeslot exclusively, and a length of the entire beacon timeslot will be lengthened. The node is adjusted based on the determined ideal quantity, and an adjustment process is illustrated in rows C and D in FIG. 3. A finally adjusted initial timeslot allocation sequence is shown in a row E in FIG. 3.

After the order adjustment is completed, a timeslot allocation step is performed. FIG. 4 schematically shows timeslots in the beacon cycle in the prior art. Based on FIG. 4, a position of the beacon timeslot in the beacon cycle and a relationship between the beacon timeslot and another timeslot can be obtained. In this implementation, the allocation of beacon timeslot for nodes in the HPLC beacon timeslot and the allocation of beacon timeslot for nodes in the HRF beacon timeslot can be obtained respectively. A plurality of beacon timeslots need to be occupied to send the standard beacon frame on the HRF channel, which means that one HRF standard beacon frame is sent simultaneously with HPLC beacon frames of a plurality of nodes. In the system, a timeslot order of the node sending an HPLC beacon in one beacon cycle is determined based on the adjusted initial timeslot allocation sequence. A timeslot allocation manner includes: allocating sequentially, to each node based on an order of sending the beacon frame by the node in the system on the HPLC link, a TDMA timeslot for sending the HPLC beacon. In this embodiment of the present disclosure, the sending the HPLC beacon is to send the beacon frame on the HPLC link.

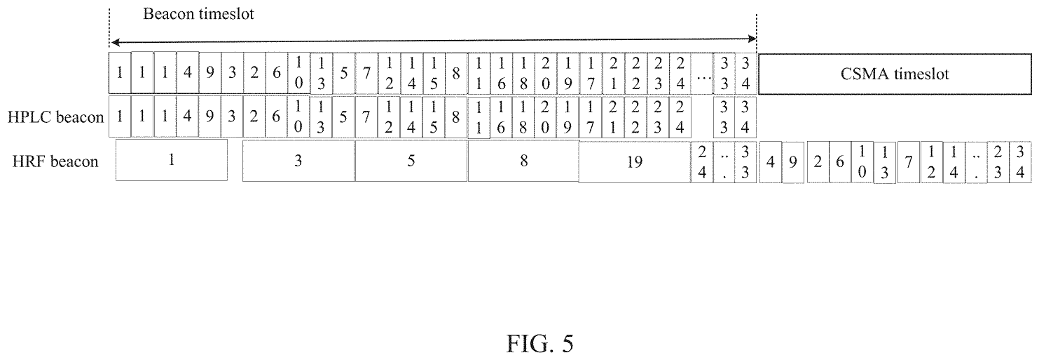

FIG. 5 schematically shows a beacon timeslot allocation obtained based on the example system 1 according to an implementation of the present disclosure. As shown in FIG. 5, as mentioned above, the root node is the first-type node. Because the root node sends a beacon on three different phases, timeslot allocation is performed starting from a third bit. An obtained timeslot allocation sequence is shown in an HPLC beacon in FIG. 5.

An HRF beacon is allocated according to a following rule: allocating, based on an order that the first-type node is prior to the second-type node, a TDMA timeslot for sending the HRF beacon. In this embodiment of the present disclosure, the sending the HRF beacon is to send the beacon frame on the HRF link. In some cases, because a total TDMA timeslot length is limited, and a timeslot of sending the HRF beacon by the first-type node is long, no sending timeslot is allocated to some nodes in the TDMA timeslot. In this case, a CSMA timeslot is allocated to these nodes for sending. A finally obtained timeslot allocation scheme is shown in the HRF beacon in FIG. 5.

Based on the adjustment solution that an adjustment quantity and an adjustment process are determined, a detailed adjustment process is described in this implementation. The system in FIG. 2 is still used as an example, and a specific implementation process is described below by using an example.

In a first step of position adjustment (also referred to as timeslot optimization in following description), an available second-type node is found. Starting from a first available second-type node of an initial timeslot allocation sequence M1, following nodes are filtered out: nodes on proxy paths of all first-type nodes before an optimized first-type node, a sub-node that is of the optimized node and connected by using the HRF link, and sub-nodes of all the first-type nodes after the optimized first-type node. A remaining second-type node sequence {TIE2, TEI4, TEI6, TEI7, TEI9, TE10, TEI11, TEI12, TEI13, TEI14, TEI15, TEI16, TEI17, TEI18, TEI20, TEI21, TEI22, TEI23, TEI24, TEI25, TEI26, TE127, TEI28, TEI29, TE130, TEI31, TEI32, TEI33, TEI34} is used for optimization. For example, when a timeslot of a first-type node TEI8 is optimized, first-type nodes TEI1, TEI3, and TEI5 are before the TEI8, a node TEI2 is on a proxy path of the TEI5, a first-type node TEI19 is after the TEI8, the TEI19 has the sub-node TEI32, and the TEI8 has sub-nodes TEI17 and TEI30 that are connected by using the HRF link. Therefore, when the timeslot of the first-type node TEI8 is optimized, the TEI2 (the node on the proxy path of the first-type node before the optimized first-type node), the TEI17 (the sub-node that is of the optimized node and connected by using the HRF link), TEI30 (the sub-node that is of the optimized node and connected by using the HRF link), and the TEI32 (the sub-node of the first-type node after the optimized first-type node) do not meet a rule and cannot be selected.

In a second step, beacon timeslots of sufficient second-type nodes selected from the selected second-type node sequence from front to back are placed after the optimized first-type node. If there are not sufficient second-type nodes, the radio beacon occupies the beacon timeslot exclusively. The used second-type node is marked as used, and a position of a next available second-type node is recorded for next filtering. For example, when a timeslot of the first-type node TEI5 is optimized, an available second-type node is selected from the available second-type node sequence from front to back. The second-type nodes TEI2, TEI4, TEI6, TEI9, TEI10, and TEI13 have been used when the first-type nodes TEI1 and TEI3 are optimized, and the TEI11 is a sub-node that is of the optimized node TEI5 and connected by using the HRF link. Therefore, the above nodes are excluded, and the TEI7, the TEI12, the TEI14, and the TEI15 are selected in turn from the available second-type node sequence to optimize the timeslot of the node TEI5.

During the timeslot optimization, a following rule needs to be considered: An order of each proxy node between the first-type node and the CCO relative to the first-type node cannot be changed. For example, the TEI4 and the TEI9 cannot be placed after the TEI19. A relative order of first-type nodes cannot be changed. In other words, a relative order of the TEI3, the TEI5, the TEI8, and TEI19 cannot be changed.

According to the above operation steps and the initial timeslot allocation sequence M1, timeslots of all first-type nodes in the initial timeslot allocation sequence M1 are sequentially optimized to form an adjusted initial timeslot allocation sequence, which is denoted as M2.

The row C in FIG. 3 shows an initial timeslot allocation sequence obtained after a node 1 is optimized, the row D shows an initial timeslot allocation sequence obtained after a node 3 is optimized; and a row E shows the adjusted initial timeslot allocation sequence, namely, the M2.

In an implementation of the present disclosure, the method further includes: when a timeslot of an optimized first-type node is optimized, if there are not sufficient available second-type nodes, in addition to using the radio beacon to occupy the beacon timeslot exclusively, breaking the rule that “the relative order of the first-type nodes cannot be changed”, and adjusting an order of same-level first-type nodes as required.

In an implementation of the present disclosure, a method for adjusting the first-type node is provided. Before the adjustment, an indicator of the first-type node needs to be obtained, which is defined as an “entropy value” herein. An entropy value of a node is determined by performing following steps: performing the level order traversal in subtrees of the node, and counting a quantity of second-type nodes during the traversal; and if the first-type node is encountered during the traversal, stopping the traversal of a branch, and taking, as the entropy value of the node, the quantity of second-type nodes that is obtained after completing the traversal.

Based on the entropy value defined in the aforementioned implementation, that an order of the first-type node in the initial timeslot allocation sequence is adjusted includes following operations: determining other same-level first-type nodes of a to-be-adjusted first-type node, determining a first-type node whose entropy value is greater than an entropy value of the to-be-adjusted first-type node from the other same-level first-type nodes, and interchanging orders of the determined first-type node and the to-be-adjusted first-type node in the initial timeslot allocation sequence. The entropy value of the node is used to represent the quantity of second-type nodes under the node. For example, when a position of a first-type node H1 is adjusted, an available second-type node is searched from the second-type node sequence. If there are not sufficient second-node types to multiplex a timeslot used by the node H1 to send the standard beacon frame on the HRF channel, another same-level first-type node that meets a condition is found, which is denoted as H2 herein. An entropy value of the node H2 needs to be greater than that of the node H1. The node H2 in the initial timeslot allocation sequence M1 is adjusted to before the node H1, the node H2 is optimized before the node H1, and a subsequent optimization step is performed. Otherwise a search at a same level is continuously performed. If the node H2 that meets the condition cannot be found at the same level, the timeslot optimization of the node H1 ends, and a next to-be-optimized node is continuously optimized.

Implementations for a plurality of scenarios are provided for description below, which are only used to understand the present disclosure and do not constitute a limitation. To simplify the description, a first-type node is denoted as an H node (shadowed node), and a second-type node is denoted as an S node.

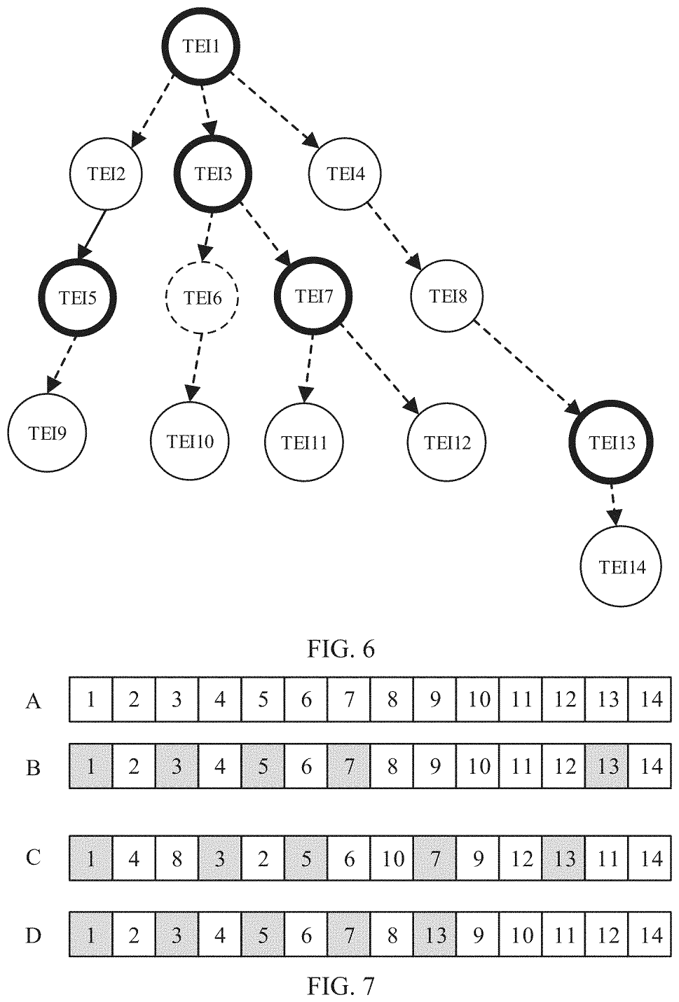

Application scenario 1: A topological structure of a system in this scenario is shown in FIG. 6. FIG. 6 schematically shows a topological relationship between a node and a link in an example system 2 according to an implementation of the present disclosure. When communication quality of an HRF channel is good, the HRF channel adopts a high-rate transmission mode, and a ratio of a transmission speed of the HRF channel to a transmission speed of an HPLC channel is 1:2, an HRF channel timeslot used by a node to send a standard beacon frame on the HRF channel has enough HPLC timeslots for multiplexing.

A topology is traversed based on a CCO, and an initial timeslot allocation sequence M1 is formed through permutation based on an order that a proxy node is prior to a leaf node, as shown in a row A in FIG. 7. This sequence is an order of sending an HPLC beacon frame by each node before optimization. FIG. 7 schematically shows a change process of the initial timeslot allocation sequence based on the example system 2 according to an implementation of the present disclosure.

When the topology is traversed, a to-be-optimized node (the node sending the standard beacon frame on the HRF channel) is denoted as the H node (shadowed node). An available S node sequence is {TEI2, TEI4, TEI6, TEI8, TEI9, TEI10, TEI11, TEI12, TEI14}, the difference is shown in a row B in FIG. 7. A timeslot of an H node TEI1 is optimized. HPLC standard beacons are sent on three different phases separately. There are enough HPLC beacon timeslots for multiplexing with an HRF beacon timeslot. A timeslot of an H node TEI3 is optimized, and the TEI2 is selected. A timeslot of an H node TEI5 is optimized. In this case, because the TEI2 in the S node sequence has been used, only the TEI4 can be selected from remaining nodes. A timeslot of an H node TEI7 is optimized. In this case, because the TEI2 and the TEI4 in the available S node sequence have been used, the TEI6 is selected from remaining nodes. A timeslot of an H node TEI13 is optimized. In this case, because the TEI2, the TEI4, and the TEI6 in the available S node sequence have been used, and the TEI8 (a node on a proxy path of the optimized H node) does not meet a rule, the TEI9 is selected from remaining nodes. An adjusted initial timeslot allocation sequence M2 is shown in a row C in FIG. 7.

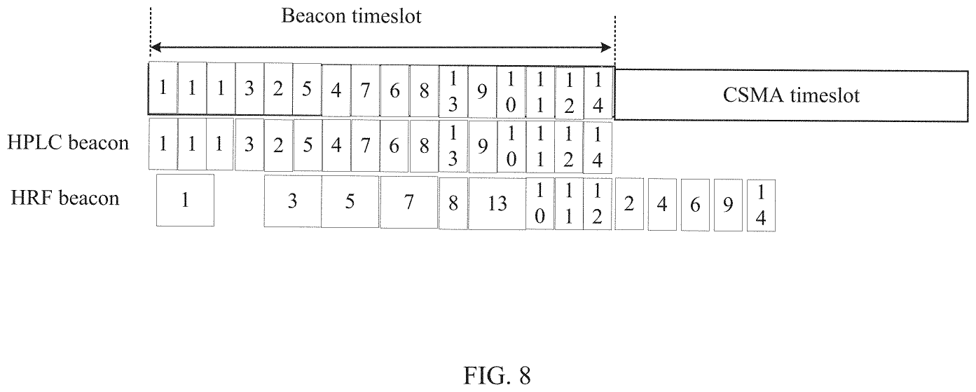

FIG. 8 schematically shows a beacon timeslot allocation obtained based on the scenario 1 of the example system 2 according to an implementation of the present disclosure. An optimized timeslot allocation is shown in FIG. 8.

Application scenario 2: A topological structure of a system in this scenario is shown in FIG. 6. When communication quality of an HRF channel is poor, the HRF channel adopts a low-rate transmission mode, and a ratio of a transmission speed of the HRF channel to a transmission speed of an HPLC channel is 1:5, an HRF channel timeslot used by a node to send a standard beacon frame on the HRF channel does not have enough HPLC timeslots for multiplexing. According to the method in the foregoing implementations, specific implementation steps are as follows:

A topology is traversed based on a CCO, and a sequence is formed through permutation based on an order that a proxy node is prior to a leaf node, as shown in a row A in FIG. 7. This sequence is an order of sending an HPLC beacon frame by each node before optimization.

When the topology is traversed, a to-be-optimized node (the node sending the standard beacon frame on the HRF channel) is denoted as the H node (shadowed node). Similarly, an available S node sequence is {TEI2, TEI4, TEI6, TEI8, TEI9, TEI10, TEI11, TEI12, TEI14}, which is shown in a row B in FIG. 7. A timeslot of an H node TEI1 is optimized. Because the TEI2 (a sub-node that is of the optimized node and connected by using an HRF link), the TEI6 (a sub-node of all H nodes after the optimized H node) do not meet a rule, the TEI4 and the TEI8 are selected from the S node sequence. A timeslot of an H node TEI3 is optimized. In this case, because the nodes TEI4 and TEI8 in the S node sequence have been selected, and the TEI6 (a sub-node that is of the optimized node and connected by using the HRF link), the TEI10 (a sub-node that is of the optimized node and connected by using the HRF link), the TEI9 (a sub-node of all H nodes after the optimized H node), the TEI11 (a sub-node of all the H nodes after the optimized H node), the TEI12 (a sub-node of all the H nodes after the optimized H node), and the TEI14 (a sub-node of all the H nodes after the optimized H node) do not meet the rule, the TEI2 is selected from remaining nodes. A timeslot of an H node TEI5 is optimized. In this case, because the TEI2, the TEI4, and the TEI8 in the S node sequence have been used, and the TEI9 (a sub-node that is of the optimized node and connected by using the HRF link), the TEI11 (a sub-node of all H nodes after the optimized H node), the TEI12 (a sub-node of all the H nodes after the optimized H node), and the TEI14 (a sub-node of all the H nodes after the optimized H node) do not meet the rule, only the TEI6 and the TEI10 can be selected. A timeslot of an H node TEI7 is optimized. In this case, because the TEI2, the TEI4, the TEI6, the TEI8, and the TEI10 in the S node sequence have been used, and the TEI11 (a sub-node that is of the optimized node and connected by using the HRF link) and the TEI14 (a sub-node of all H nodes after the optimized H node) do not meet the rule, only the TEI9 and the TEI12 can be selected. A timeslot of an H node TEI13 is optimized. In this case, because the TEI2, the TEI4, the TEI6, the TEI8, the TEI9, the TEI10, and the TEI12 in the available S node sequence have been used, and the TEI14 (a sub-node that is of the optimized node and connected by using the HRF link) does not meet the rule, only the remaining TEI11 can be selected. A finally obtained sequence is shown in a row D in FIG. 7.

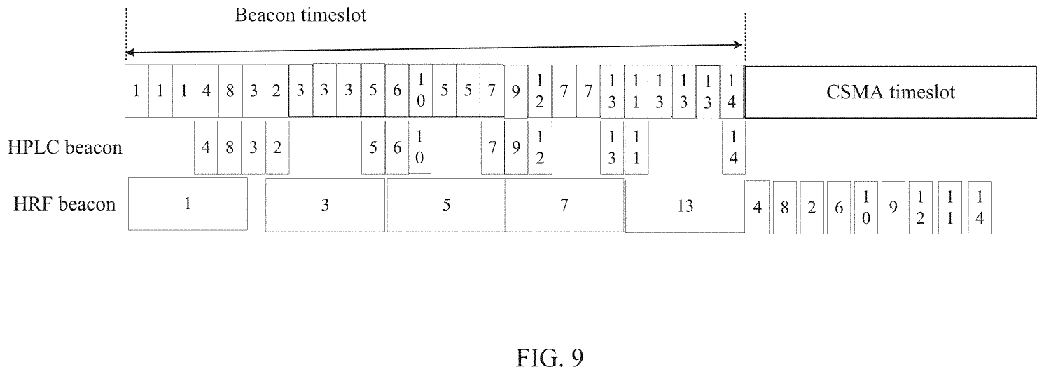

FIG. 9 schematically shows a beacon timeslot allocation obtained based on the scenario 2 of the example system 2 according to an implementation of the present disclosure. An optimized timeslot allocation is shown in FIG. 9.

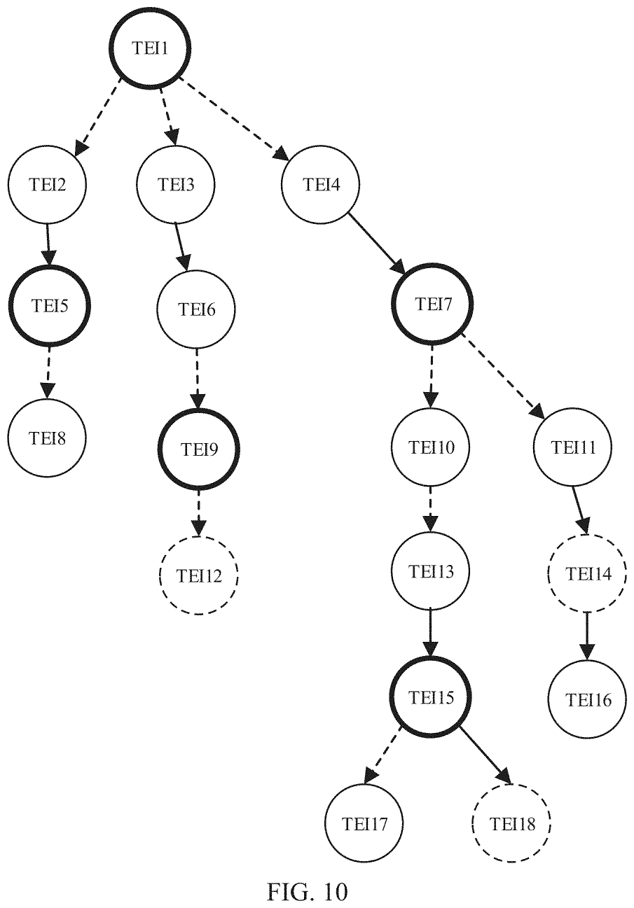

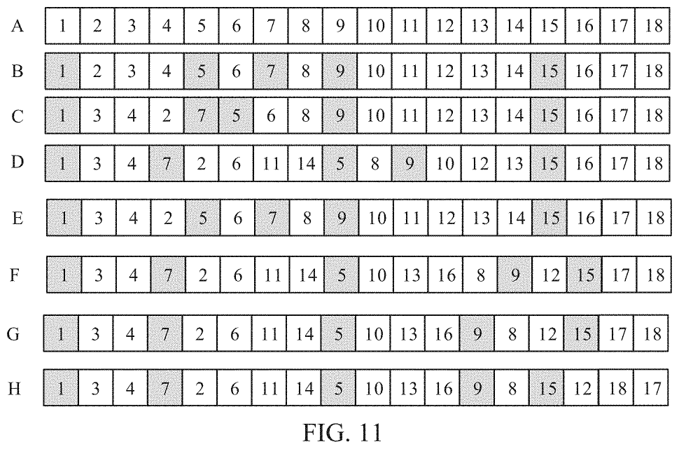

Application scenario 3: A topological structure of a system in this scenario is shown in FIG. 10. FIG. 10 schematically shows a topological relationship between a node and a link in an example system 3 according to an implementation of the present disclosure. FIG. 10 shows that an HRF channel timeslot used by a node to send a standard beacon frame on an HRF channel does not have enough HPLC timeslots for multiplexing. This problem is resolved by changing an order of same-level H nodes. Specific implementation steps are as follows:

FIG. 11 schematically shows a change process of an initial timeslot allocation sequence based on the example system 3 according to an implementation of the present disclosure. A topology is traversed based on a CCO, and a sequence M1 (shown in a row A in FIG. 11) is formed through permutation based on an order that a proxy node is prior to a leaf node. This sequence is an order of sending an HPLC beacon frame by each node before optimization. When the topology is traversed, a to-be-optimized node (the node sending the standard beacon frame on the HRF channel) is denoted as the H node (shadowed node), as shown in a sequence in a row B in FIG. 11. An available S node sequence is {TEI2, TEI3, TEI4, TEI6, TEI8, TEI10, TEI11, TEI12, TEI13, TEI14, TEI16, TEI17, TEI8}.

A timeslot of an H node TEI1 is optimized. In this case, because the node TEI2 (a sub-node that is of the optimized node and connected by using an HRF link) in the S node sequence does not meet a rule, the TEI3 and the TEI4 are selected from the S node sequence. A timeslot allocation sequence obtained after this step is shown in a row C in FIG. 11.

A timeslot of an H node TEI5 is optimized. In this case, because the nodes TEI3 and TEI4 in the S node sequence have been selected, and the TEI2 (a proxy node between the H node and the COO), the TEI8 (a sub-node that is of the optimized node and connected by using the HRF link), the TEI10 (a sub-node of all H nodes after the optimized H node), the TEI11 (a sub-node of all the H nodes after the optimized H node), the TEI12 (a sub-node of all the H nodes after the optimized H node), the TEI13 (a sub-node of all the H nodes after the optimized H node), the TEI14 (a sub-node of all the H nodes after the optimized H node), the TEI16 (a sub-node of all the H nodes after the optimized H node), the TEI17 (a sub-node of all the H nodes after the optimized H node), and the TEI18 (a sub-node of all the H nodes after the optimized H node) do not meet the rule, only the TEI6 can be selected from remaining nodes. However, one HPLC timeslot is not enough to multiplex the timeslot for sending the standard beacon frame on the HRF channel. Therefore, it is considered to change an order of same-level H nodes. Based on the topological structure, the TEI5 is at a same level as an H node TEI7. An entropy value of the TEI5 is 0, and an entropy value of the TEI7 is 5 (S nodes meeting an entropy value statistic are the TEI10, the TEI11, the TEI13, the TEI14, and the TEI16). The entropy value of the TEI7 is greater than that of the TEI5. Therefore, the TEI7 is adjusted to before the TEI5, and a timeslot of the TEI7 is optimized. A timeslot allocation sequence obtained after this step is shown in a row D in FIG. 11.

The timeslot of the H node TEI7 is optimized. In this case, because the nodes TEI3 and TEI4 in the S node sequence have been selected, and the TEI10 (a sub-node that is of the optimized node and connected by using the HRF link), the TEI13 (a sub-node that is of the optimized node and connected by using the HRF link), the TEI17 (a sub-node that is of the optimized node and connected by using the HRF link), the TEI18 (a sub-node that is of the optimized node and connected by using the HRF link), the TEI8 (a sub-node of all H nodes after the optimized H node), and the TEI12 (a sub-node of all the H nodes after the optimized H node) do not meet the rule, the TEI2, the TEI6, the TEI11, and the TEI14 are selected from remaining nodes to optimize the timeslot of the TEI7. A timeslot allocation sequence obtained after this step is shown in a row E in FIG. 11.

The timeslot of the H node TEI5 is optimized. In this case, because the nodes TEI2, TEI3, TEI4, TEI6, TEI11, and TEI14 in the S node sequence have been selected, and the TEI8 (the sub-node that is of the optimized node and connected by using the HRF link), the TEI12 (the sub-node of all the H nodes after the optimized H node), TEI17 (the sub-node of all the H nodes after the optimized H node), and the TEI18 (the sub-node of all the H nodes after the optimized H node) do not meet the rule, only the TEI10, the TEI13, and the TEI16 can be selected from remaining nodes. However, three HPLC timeslot are not enough to multiplex the timeslot for sending the standard beacon frame on the HRF channel. Therefore, it is considered to change an order of same-level H nodes. However, there is no to-be-optimized H node that is at the same level as the TEI5. Therefore, no node undergoes the order change. A timeslot allocation sequence obtained after the timeslot of the TEI5 is optimized is shown in a row F in FIG. 11.

A timeslot of an H node TEI9 is optimized. In this case, because the nodes TEI2, TEI3, TEI4, TEI6, TEI10, TEI11, TEI13, TEI14, and TEI6 in the S node sequence have been selected, and the TEI12 (a sub-node that is of the optimized H node and connected by using the HRF link), the TEI17 (a sub-node of all H nodes after the optimized H node), and the TEI18 (a sub-node of all the H nodes after the optimized H node) do not meet the rule, only the TEI8 can be selected from remaining nodes. However, one HPLC timeslot is not enough to multiplex the timeslot for sending the standard beacon frame on the HRF channel. Therefore, it is considered to change an order of same-level H nodes. However, there is no to-be-optimized H node that is at a same level as the TEI9. Therefore, no node undergoes the order change. A timeslot allocation sequence obtained after the timeslot of the TEI9 is optimized is shown in a row G in FIG. 11.

A timeslot of an H node TEI15 is optimized. In this case, because the nodes TEI2, TEI3, TEI4, TEI6, TEI8, TEI10, TEI11, TEI13, TEI14, and TEI6 in the S node sequence have been selected, and the TEI117 (a sub-node that is of the optimized node and connected by using the HRF link) does not meet the rule, only the TEI12 and the TEI18 can be selected from remaining nodes. However, two HPLC timeslots are not enough to multiplex the timeslot for sending the standard beacon frame on the HRF channel. Therefore, it is considered to change an order of same-level H nodes. However, there is no to-be-optimized H node that is at a same level as the TEI15. Therefore, no node undergoes the order change. A timeslot allocation sequence obtained after this step is shown in a row H in FIG. 11. In addition, the timeslot allocation sequence at this time is an adjusted timeslot allocation sequence.

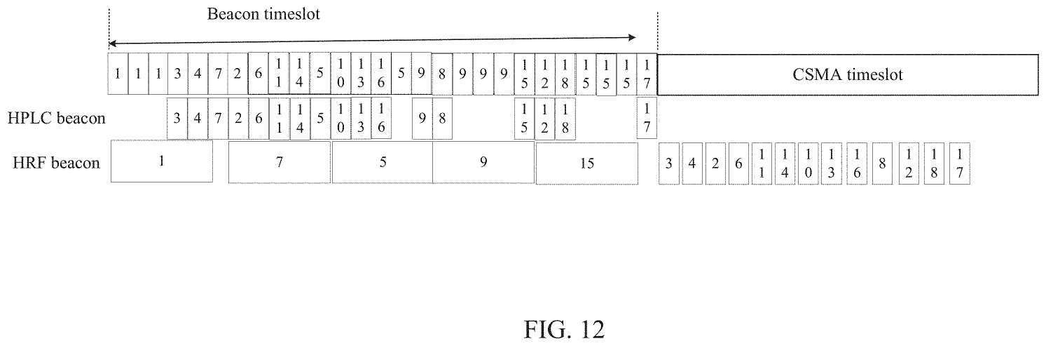

FIG. 12 schematically shows a beacon timeslot allocation obtained based on the example system 3 according to an implementation of the present disclosure. An optimized timeslot allocation is shown in FIG. 12.

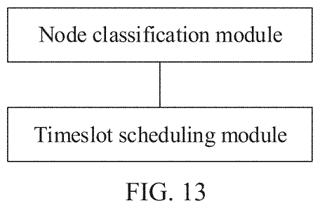

Based on a same inventive concept, the present disclosure further provides a beacon timeslot allocation apparatus, applied to a system with HPLC and HRF dual-mode networking. FIG. 13 is a schematic structural diagram of a beacon timeslot allocation apparatus according to an implementation of the present disclosure. As shown in FIG. 13, the apparatus includes: a node classification module configured to determine, based on a type of a beacon frame sent by a node in the system on an HRF link, a node sending a standard beacon frame as a first-type node, and a node sending a simplified beacon frame as a second-type node; and a timeslot scheduling module configured to: in a process of sending a beacon frame on the HRF link by one first-type node, schedule at least one first-type node and/or second-type node that have/has not been scheduled to perform sending on an HPLC link yet to send a beacon frame on the HPLC link, where the scheduled first-type node and/or second-type node do/does not include the one first-type node or a node on a path between the one first-type node and a CCO in the system.

In some optional implementations, when there are a plurality of first-type nodes in the system, a sending order of the plurality of first-type nodes on the HRF link is determined based on a topological relationship between the plurality of first-type nodes and the CCO in the system.

In some optional implementations, in the process of sending the beacon frame on the HRF link by the one first-type node, when there is more than one first-type node and/or second-type node scheduled to send a beacon frame on the HPLC link, a sending order of the scheduled nodes on the HPLC link is determined based on a topological relationship between the scheduled nodes and the CCO in the system.

In some optional implementations, that the sending order of the plurality of first-type nodes on the HRF link is determined based on the topological relationship between the plurality of first-type nodes and the CCO in the system, or the sending order of the scheduled nodes on the HPLC link is determined based on the topological relationship between the scheduled nodes and the CCO in the system includes following operations: determining the sending order according to a rule that a non-leaf node is prior to a leaf node; when there are only non-leaf nodes, determining the sending order through level order traversal; and when there are only leaf nodes, determining the sending order from left to right based on a topological graph.

In some optional implementations, in the process of sending the beacon frame on the HRF link by the one first-type node, the at least one first-type node and/or second-type node, which have/has not been scheduled to perform sending on the HPLC link yet, scheduled to send the beacon frame on the HPLC link do/does not include: a sub-node that is of the one first-type node and connected by using the HRF link; an ancestor node of the first-type node before the one first-type node; and a descendant node of the first-type node after the one first-type node.

In some optional implementations, in the process of sending the beacon frame on the HRF link by the one first-type node, a quantity of nodes scheduled to send the beacon frame on the HPLC link is jointly determined based on following parameters: time for the first-type node to send the beacon frame on the HRF link, and time for the second-type node to send the beacon frame on the HPLC link.

In some optional implementations, a ratio of the time for the first-type node to send the beacon frame on the HRF link to the time for the second-type node to send the beacon frame on the HPLC link is calculated; and the ratio is rounded up, and then 1 is subtracted from an obtained ratio as a quantity of second-type nodes scheduled to send the beacon frame on the HPLC link.

In some optional implementations, the time for the first-type node to send the beacon frame on the HRF link and the time for the second-type node to send the beacon frame on the HPLC link are both related to a length of the beacon frame, and are also related to rates of respective links.

In some optional implementations, the apparatus is further configured to interchange positions of same-level first-type nodes in the sending order reciprocally.

In some optional implementations, the positions of the same-level first-type nodes are interchanged reciprocally when a following configuration is met: among the same-level first-type nodes, an entropy value of an anterior first-type node is less than an entropy value of a posterior first-type node, where an entropy value of a node is used to represent a quantity of second-type nodes under the first-type node.

In some optional implementations, the entropy value of the first-type node is determined by performing following steps: performing level order traversal in subtrees of the first-type node, and counting the quantity of second-type nodes during the traversal; and if the first-type node is encountered during the traversal, stopping the traversal of a branch, and taking, as the entropy value of the first-type node, the quantity of second-type nodes that is obtained after completing the traversal.

In some optional implementations, the apparatus is further configured to allocate sequentially, to each node based on an order of sending the beacon frame by the node in the system on the HPLC link, a TDMA timeslot for sending an HPLC beacon.

In some optional implementations, the apparatus is further configured to allocate, based on an order that the first-type node is prior to the second-type node, a TDMA timeslot for sending an HRF beacon.

In some optional implementations, the apparatus is further configured to allocate, based on an order that the first-type node is prior to the second-type node, a TDMA timeslot and a CSMA timeslot for sending an HRF beacon.

For specific limitations on the functional modules in the above-mentioned beacon timeslot allocation apparatus, reference may be made to the above limitations on the beacon timeslot allocation method, and details are not described herein again. The modules of the beacon timeslot allocation apparatus may be implemented in whole or in part by software, hardware, or any combination thereof. The modules may be embedded in or independent of a processor of a computer device in a form of hardware, or stored in a memory of the computer device in a form of software, such that the processor can easily invoke and execute corresponding operations of the modules.

In some optional implementations, the node classification module and the timeslot scheduling module each may be one or more processors or controllers that each have a communication interface, can realize a communication protocol, and may further include a memory, a related interface and system transmission bus, and the like if necessary. The processor or controller executes program-related code to implement a corresponding function. Alternatively, the node classification module and the timeslot scheduling module share a controller or processor, a memory, and other devices. The shared controller or processor executes program-related code to implement a corresponding function.

In some implementations of the present disclosure, a beacon timeslot allocation device is further provided, including a memory, a processor, and a computer program stored in the memory and able to run on the processor, where the computer program is executed by the processor to implement steps of the aforementioned beacon timeslot allocation method. The processor herein has numerical calculation and logical operation functions. The processor has at least a central processing unit (CPU) with a data processing capability, a random access memory (RAM), a read-only memory (ROM), a variety of input/output (I/O) ports, and an interrupt system. The processor contains a kernel, and the kernel calls a corresponding program unit from the memory. At least one kernel may be set, and the aforementioned method is implemented by adjusting kernel parameters. The memory may include a non-persistent memory, a RAM and/or a non-volatile memory in computer-readable media, such as a ROM or a flash RAM. The memory includes at least one storage chip. The above devices may be integrated in a form of a chip.

In some implementations, a dual-mode communication networking device includes an HPLC communication module and an HRF communication module, where both the HPLC communication module and the HRF communication module are communicatively coupled with a controller, and the controller is configured to control the HPLC communication module and the HRF communication module to send a beacon on a beacon sending timeslot determined according to the aforementioned beacon timeslot allocation method.

In some optional implementations, the HPLC communication module and the HRF communication module each may be one or more processors or controllers that each have a communication interface, can realize a communication protocol, and may further include a memory, a related interface and system transmission bus, and the like if necessary. The processor or controller executes program-related code to implement a corresponding function. Alternatively, the HPLC communication module and the HRF communication module share a controller or processor, a memory, and other devices. The shared controller or processor executes program-related code to implement a corresponding function.

In an implementation of the present disclosure, a computer-readable storage medium is further provided, where the computer-readable storage medium stores an instruction, and when the instruction runs on a computer, the instruction is executed by a processor to perform the aforementioned beacon timeslot allocation method.

In an implementation of the present disclosure, a computer program product is further provided, including a computer program. The computer program is executed by a processor to implement the aforementioned beacon timeslot allocation method.

Those skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may be in a form of a computer program product that is implemented on one or more computer-usable storage media (including but not limited to a magnetic disk memory, a CD-ROM, an optical memory, and the like) that include computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, such that the instructions executed by a computer or a processor of another programmable data processing device generate an apparatus for implementing a specific function in one or more processes in the flowcharts and/or in one or more blocks in the block diagrams.

These computer program instructions may be stored in a computer-readable memory that can instruct a computer or another programmable data processing device to work in a specific manner, such that the instructions stored in the computer-readable memory generate an artifact that includes an instruction apparatus. The instruction apparatus implements a specific function in one or more processes in the flowcharts and/or in one or more blocks in the block diagrams.

These computer program instructions may be alternatively loaded onto a computer or another programmable data processing device, such that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more CPUs, an I/O interface, a network interface, and a memory.

The memory may include a non-persistent memory, a RAM and/or a non-volatile memory in computer-readable media, such as a ROM or a flash RAM. The memory is an example of a computer-readable medium.

The computer-readable medium includes both persistent, non-persistent, removable, and non-removable media, and storage of information may be implemented by any method or technology. The information may be computer-readable instructions, data structures, modules of programs, or other data. Examples of the computer storage medium include, but are not limited to, a phase-change random access memory (PRAM), a static random access memory (SRAM), a dynamic random access memory (DRAM), other types of RAMs, a ROM, an electrically erasable programmable read-only memory (EEPROM), a flash memory or another memory technology, a CD-ROM, a digital versatile disk (DVD) or another optical storage device, a magnetic cassette tape, and a magnetic tape disk storage device or another magnetic storage device or any other non-transmission medium that can be used to store information that can be accessed by a computing device. The computer-readable medium, as defined herein, excludes non-transitory computer-readable media (transitory media), such as modulated data signals and carrier waves.

It should also be noted that the term “comprise”, “include”, or any other variant thereof is intended to encompass a non-exclusive inclusion, such that a process, method, product, or device that includes a series of elements includes not only those elements, but also other elements not explicitly listed, or elements that are inherent to such a process, method, product, or device. Without more restrictions, an element defined by the phrase “including a . . . ” does not exclude the presence of another same element in a process, method, product, or device that includes the element.

The above described are merely preferred embodiments of the present disclosure, which are not intended to limit the present disclosure. Various changes and modifications can be made to the present disclosure by those skilled in the art. Any modifications, equivalent replacements, improvements, etc. made within the spirit and principle of the present disclosure should be included within the protection scope of the claims of the present disclosure.

1. A beacon timeslot allocation method, applied to a system with dual-mode networking of a highspeed power line carrier (HPLC) link and a highspeed radio frequency (HRF) link, wherein the method comprises:
determining, based on a type of a beacon frame sent by a node in the system on the HRF link, a node sending a standard beacon frame as a first-type node, and a node sending a simplified beacon frame as a second-type node; and
in a process of sending a beacon frame on the HRF link by one first-type node, scheduling at least one first-type node and/or second-type node that have/has not been scheduled to perform sending on the HPLC link yet to send a beacon frame on the HPLC link, wherein the scheduled first-type node and/or second-type node do/does not comprise the one first-type node or a node on a path between the one first-type node and a central coordinator (CCO) in the system.

2. The method according to claim 1, wherein when there are a plurality of first-type nodes in the system, the method further comprises:
determining a sending order of the plurality of first-type nodes on the HRF link based on a topological relationship between the plurality of first-type nodes and the CCO in the system.

3. The method according to claim 2, wherein in the process of sending the beacon frame on the HRF link by the one first-type node, when there is more than one first-type node and/or second-type node scheduled to send a beacon frame on the HPLC link, the method further comprises:
determining a sending order of scheduled nodes on the HPLC link based on a topological relationship between the scheduled nodes and the CCO in the system.

4. The method according to claim 3, wherein the determining a sending order of the plurality of first-type nodes on the HRF link based on a topological relationship between the plurality of first-type nodes and the CCO in the system, or the determining a sending order of scheduled nodes on the HPLC link based on a topological relationship between the scheduled nodes and the CCO in the system comprises:
determining the sending order according to a rule that a non-leaf node is prior to a leaf node;
when there are only non-leaf nodes, determining the sending order through level order traversal; and
when there are only leaf nodes, determining the sending order from left to right based on a topological graph.

5. The method according to claim 4, wherein in the process of sending the beacon frame on the HRF link by the one first-type node, the at least one first-type node and/or second-type node, which have/has not been scheduled to perform sending on the HPLC link yet, scheduled to send the beacon frame on the HPLC link do/does not comprise:
a sub-node that is of the one first-type node and connected by using the HRF link;
an ancestor node of the first-type node before the one first-type node; and
a descendant node of the first-type node after the one first-type node.

6. The method according to claim 1, wherein in the process of sending the beacon frame on the HRF link by the one first-type node, quantities and/or a quantity of first-type nodes and/or second-type nodes scheduled to send the beacon frame on the HPLC link are/is jointly determined based on following parameters: time for the first-type node to send the beacon frame on the HRF link, and time for the second-type node to send the beacon frame on the HPLC link.

7. The method according to claim 6, wherein the method further comprises:
calculating a ratio of the time for the first-type node to send the beacon frame on the HRF link to the time for the second-type node to send the beacon frame on the HPLC link; and
rounding up the ratio, and then subtracting 1 from an obtained ratio as the quantities/the quantity of first-type nodes and/or second-type nodes scheduled to send the beacon frame on the HPLC link.

8. The method according to claim 7, wherein the time for the first-type node to send the beacon frame on the HRF link and the time for the second-type node to send the beacon frame on the HPLC link are both related to a length of the beacon frame, and are also related to rates of respective links.

9. The method according to claim 2, wherein the method further comprises: interchanging positions of same-level first-type nodes in the sending order reciprocally.

10. The method according to claim 9, wherein the positions of the same-level first-type nodes are interchanged reciprocally when a following configuration is met:
among the same-level first-type nodes, an entropy value of an anterior first-type node is less than an entropy value of a posterior first-type node, wherein the entropy value of the first-type node is used to represent a quantity of second-type nodes under the first-type node.

11. The method according to claim 10, wherein the entropy value of the first-type node is determined by performing following steps:
performing level order traversal in subtrees of the first-type node, and counting the quantity of second-type nodes during the traversal; and
if the first-type node is encountered during the traversal, stopping the traversal of a branch, and taking, as the entropy value of the first-type node, the quantity of second-type nodes that is obtained after completing the traversal.

12. The method according to claim 1, wherein the method further comprises:
allocating sequentially, to each node based on an order of sending the beacon frame by the node in the system on the HPLC link, a time division multiple address (TDMA) timeslot for sending an HPLC beacon.

13. The method according to claim 12, wherein the method further comprises:
allocating, based on an order that the first-type node is prior to the second-type node, a TDMA timeslot for sending an HRF beacon.

14. The method according to claim 12, wherein the method further comprises:
allocating, based on an order that the first-type node is prior to the second-type node, a TDMA timeslot and a carrier sense multiple access (CSMA) timeslot for sending an HRF beacon.

15. A beacon timeslot allocation apparatus, applied to a system with dual-mode networking of an HPLC link and an HRF link, wherein the apparatus comprises:
a node classification module configured to determine, based on a type of a beacon frame sent by a node in the system on the HRF link, a node sending a standard beacon frame as a first-type node, and a node sending a simplified beacon frame as a second-type node; and
a timeslot scheduling module configured to: in a process of sending a beacon frame on the HRF link by one first-type node, schedule at least one first-type node and/or second-type node that have/has not been scheduled to perform sending on the HPLC link yet to send a beacon frame on the HPLC link, wherein the scheduled first-type node and/or second-type node do/does not comprise the one first-type node or a node on a path between the one first-type node and a CCO in the system.

16. The apparatus according to claim 15, wherein when there are a plurality of first-type nodes in the system, a sending order of the plurality of first-type nodes on the HRF link is determined based on a topological relationship between the plurality of first-type nodes and the CCO in the system.

17. The apparatus according to claim 16, wherein in the process of sending the beacon frame on the HRF link by the one first-type node, when there is more than one first-type node and/or second-type node scheduled to send a beacon frame on the HPLC link, a sending order of scheduled nodes on the HPLC link is determined based on a topological relationship between the scheduled nodes and the CCO in the system.

18. The apparatus according to claim 17, wherein that the sending order of the plurality of first-type nodes on the HRF link is determined based on the topological relationship between the plurality of first-type nodes and the CCO in the system, or the sending order of scheduled nodes on the HPLC link is determined based on the topological relationship between the scheduled nodes and the CCO in the system comprises following operations:
determining the sending order according to a rule that a non-leaf node is prior to a leaf node;
when there are only non-leaf nodes, determining the sending order through level order traversal; and
when there are only leaf nodes, determining the sending order from left to right based on a topological graph.

19. The apparatus according to claim 18, wherein in the process of sending the beacon frame on the HRF link by the one first-type node, the at least one first-type node and/or second-type node, which have/has not been scheduled to perform sending on the HPLC link yet, scheduled to send the beacon frame on the HPLC link, do/does not comprise:
a sub-node that is of the one first-type node and connected by using the HRF link;
an ancestor node of the first-type node before the one first-type node; and
a descendant node of the first-type node after the one first-type node.

20. The apparatus according to claim 15, wherein in the process of sending the beacon frame on the HRF link by the one first-type node, a quantity of nodes scheduled to send the beacon frame on the HPLC link is jointly determined based on following parameters: time for the first-type node to send the beacon frame on the HRF link, and time for the second-type node to send the beacon frame on the HPLC link.

21. The apparatus according to claim 20, wherein a ratio of the time for the first-type node to send the beacon frame on the HRF link to the time for the second-type node to send the beacon frame on the HPLC link is calculated; and
the ratio is rounded up, and then 1 is subtracted from an obtained ratio as quantities/a quantity of first-type nodes and/or second-type nodes scheduled to send the beacon frame on the HPLC link.

22. The apparatus according to claim 21, wherein the time for the first-type node to send the beacon frame on the HRF link and the time for the second-type node to send the beacon frame on the HPLC link are both related to a length of the beacon frame, and are also related to rates of respective links.

23. The apparatus according to claim 16, wherein the apparatus is further configured to interchange positions of same-level first-type nodes in the sending order reciprocally.

24. The apparatus according to claim 23, wherein the positions of the same-level first-type nodes are interchanged reciprocally when a following configuration is met:
among the same-level first-type nodes, an entropy value of an anterior first-type node is less than an entropy value of a posterior first-type node, wherein an entropy value of a node is used to represent a quantity of second-type nodes under the first-type node.

25. The apparatus according to claim 24, wherein the entropy value of the first-type node is determined by performing following steps:
performing level order traversal in subtrees of the first-type node, and counting the quantity of second-type nodes during the traversal; and
if the first-type node is encountered during the traversal, stopping the traversal of a branch, and taking, as the entropy value of the first-type node, the quantity of second-type nodes that is obtained after completing the traversal.

26. The apparatus according to claim 15, wherein the apparatus is further configured to allocate sequentially, to each node based on an order of sending the beacon frame by the node in the system on the HPLC link, a TDMA timeslot for sending an HPLC beacon.

27. The apparatus according to claim 26, wherein the apparatus is further configured to allocate, based on an order that the first-type node is prior to the second-type node, a TDMA timeslot for sending an HRF beacon.

28. The apparatus according to claim 26, wherein the apparatus is further configured to:
allocate, based on an order that the first-type node is prior to the second-type node, a TDMA timeslot and a CSMA timeslot for sending an HRF beacon.

29. A beacon timeslot allocation device, comprising a memory, a processor, and a computer program stored in the memory and able to run on the processor, wherein the processor executes the computer program to implement steps of the beacon timeslot allocation method according to claim 1.

30. A dual-mode communication networking device, comprising an HPLC communication module and an HRF communication module, wherein both the HPLC communication module and the HRF communication module are communicatively coupled with a controller, and the controller is configured to control the HPLC communication module and the HRF communication module to send a beacon on a beacon sending timeslot determined according to the beacon timeslot allocation method according to claim 1.

31. A chip, comprising a memory, a processor, and a computer program stored in the memory and able to run on the processor, wherein the processor executes the computer program to implement steps of the beacon timeslot allocation method according to claim 1.

32. A computer-readable storage medium, wherein the computer-readable storage medium stores an instruction, and when the instruction runs on a computer, the computer performs steps of the beacon timeslot allocation method according to claim 1.
